(19) United States
(12) Patent Application Publication
(10) Pub. No.: US 2009/0027316 A1
(43) Pub. Date: Jan. 29, 2009

(54) Organic light emitting display and driving method thereof

(76) Inventor: Do-Ik Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/220,556

(22) Filed: Jul. 25, 2008

(30) Foreign Application Priority Data
Jul. 27, 2007 (KR) 10-2007-0075560

(51) Int. Cl. G09G 3/30

(52) U.S. Cl. 345/80

(57) ABSTRACT

An organic light emitting display is disclosed. The organic light emitting display has a test pixel which receives power from a power supply, where the voltage of the power is adjusted so as to cause a certain amount of current to flow in the test pixel. The adjusted voltage is then used to power the rest of the pixel array of the display.

### CROSS-REFERENCE TO RELATED APPLICATION

This application claims priority to and the benefit of Korean Patent Application No. 10-2007-0075560, filed on Jul. 27, 2007, in the Korean Intellectual Property Office, the entire content of which is incorporated herein by reference.

### BACKGROUND

1. Field

The field relates to an organic light emitting display and a driving method thereof, and more particularly to an organic light emitting display and a driving method thereof, which display images of uniform luminance regardless of a temperature and a resistance change of an organic light emitting diode.

2. Description of Related Technology

Various flat plate displays with reduced weight and volume when compared to cathode ray tubes (CRT) have been developed. Flat panel displays may, for example, take the form of a liquid crystal displays (LCD), a field emission displays (FED), a plasma display panels (PDP), and an organic light emitting displays.

An organic light emitting displays make use of organic light emitting diodes that emit light by re-combination of electrons and holes. The organic light emitting display has advantages of high response speed and small power consumption.

FIG. 1 is a view showing a pixel of a conventional organic light emitting display.

With reference to FIG. 1, the pixel 4 of a conventional organic light emitting display includes an organic light emitting diode OLED and a pixel circuit 2. The pixel circuit 2 is coupled to a data line Dm and a scan line Sn, and controls the organic light emitting diode OLED.

An anode electrode of the organic light emitting diode OLED is coupled to a pixel circuit 2, and a cathode electrode thereof is coupled to a second power source ELVSS. The organic light emitting diode OLED generates light of a luminance corresponding to an electric current from the pixel circuit 2.

When a scan signal is supplied to the scan line Sn, the pixel circuit 2 controls an amount of an electric current provided to the organic light emitting diode OLED corresponding to a data signal provided to the data line Dm. So as to do this, the pixel circuit 2 includes a second transistor M2, a first transistor M1, and a storage capacitor Cst. The second transistor M2 is coupled between a first power source ELVDD and the organic light emitting diode OLED. The first transistor M1 is coupled between the data line Dm and the scan line Sn. The storage capacitor Cst is coupled between a gate electrode and a first electrode of the second transistor M2.

A gate electrode of the first transistor M1 is coupled to the scan line Sn, and a first electrode thereof is coupled to the data line Dm. A second electrode of the first transistor M1 is coupled with one terminal of the storage capacitor Cst. Here, the first electrode is a source electrode or a drain electrode, and the second electrode is the electrode different from the first electrode. For example, when the first electrode is the source electrode, the second electrode is the drain electrode. When a scan signal is supplied to the first transistor M1 coupled with the scan line Sn and the data line Dm, it is turned-on to provide a data signal from the data line Dm to the storage capacitor Cst. As a result, the storage capacitor Cst is charged with a voltage corresponding to the data signal.

The gate electrode of the second transistor M2 is coupled to one terminal of the storage capacitor Cst, and a first electrode thereof is coupled to another terminal of the storage capacitor Cst and a first power source ELVDD. Further, a second electrode of the second transistor M2 is coupled with an anode electrode of the organic light emitting diode OLED. The second transistor M2 controls the amount of electric current flowing from the first power source ELVDD to the second power source ELVSS through the organic light emitting according to the voltage charged in the storage capacitor Cst. The organic light emitting diode OLED emits light corresponding to the electric current supplied from the second transistor M2.

In practice, the pixel 4 of the conventional organic light emitting display displays images of desired luminance by repeating the aforementioned procedure. On the other hand, during a digital drive in which the second transistor M2 functions as a switch, the voltage of the first power source ELVDD and the voltage of the second power source ELVSS are supplied to the organic light emitting diode OLED. Accordingly, the organic light emitting diode OLED emits light with a voltage regulation drive. In the digital drive method, an electric current is sensitively changed due to a temperature and a resistance increase according to a degradation of the organic light emitting diode OLED. This causes a problem, which results in images of undesired luminance.

In detail, the current flowing from the pixel circuit 2 to the organic light emitting diode OLED changes according to a variation of temperature. In this case, there arises a problem that luminance of displayed image is changed according to the variation of the temperature. Further, as time goes by, the organic light emitting diode OLED is degraded. When the organic light emitting diode OLED is degraded, resistance of the organic light emitting diode OLED is increased. Accordingly, the electric current flowing to the organic light emitting diode OLED is reduced corresponding to the same voltage. This causes the luminance of images to be reduced.

### SUMMARY OF CERTAIN INVENTIVE ASEPECTS

One aspect is an organic light emitting display, including a scan driver configured to sequentially supply a scan signal to scan lines during each scan period of a plurality of sub frames of one frame, a data driver configured to supply a data signal to data lines when the scan signal is supplied, a pixel portion, including pixels configured to receive a first power source supplied through a power source line and a second power source, and a test pixel included in the pixel portion. The test pixel is configured to receive the second power source and a third power source from a power source block, and the power source block is configured to control the voltage value of the third power source according to a current supplied to the test pixel and to generate and supply the first power source to the pixels, where the first power source has substantially the same voltage value as that of the third power source.

Another aspect is a method of driving an organic light emitting display which includes a pixel portion disposed near intersections of scan lines and data lines and including pixels coupled between a first power source and a second power source, where a frame is divided in a plurality of sub frames. The method includes supplying a voltage of a third power source to a test pixel of the pixel portion, extracting a voltage corresponding to an electric current flowing through the test pixel using a sensing resistor, adjusting the voltage of the third power source so that the extracted voltage is substantially the same as a reference voltage, and adjusting a voltage of the first power source to be substantially the same as that of the third power source.

Another aspect is an organic light emitting display, including a pixel portion having a plurality of pixels configured to receive a first power source, and a power source block, configured to generate the first power source by adjusting a voltage applied to a test pixel of the plurality of pixels until a desired current is supplied to the test pixel, and adjusting the first power source until the first power source has a voltage value substantially equal to the adjusted voltage applied to the test pixel.

### BRIEF DESCRIPTION OF THE DRAWINGS

These and/or other embodiments and features will become apparent and more readily appreciated from the following description of the certain exemplary embodiments, taken in conjunction with the accompanying drawings of which:

FIG. 1 is a view showing a pixel of a general organic light emitting display;

FIG. 2 is a view showing an organic light emitting display according to one embodiment;

FIG. 3 is a view showing one frame of the organic light emitting display according to an embodiment;

FIG. 4 is a view showing a coupling structure of the power source block and the pixel shown in FIG. 2; and

FIG. 5 is a view showing an electric current flowing through a sensing resistor shown in FIG. 2.

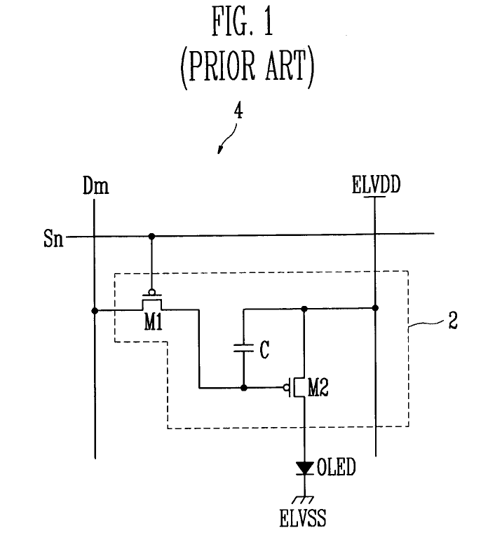

### DETAILED DESCRIPTION OF CERTAIN INVENTIVE EMBODIMENTS

Hereinafter, certain exemplary embodiments will be described with reference to the accompanying drawings. When a first element is described as being coupled to a second element, the first element may be not only directly coupled to the second element but may be indirectly coupled to the second element via a third element. Further, elements that are not essential to the complete understanding of the invention may be omitted for clarity. Also, like reference numerals generally refer to like elements throughout.

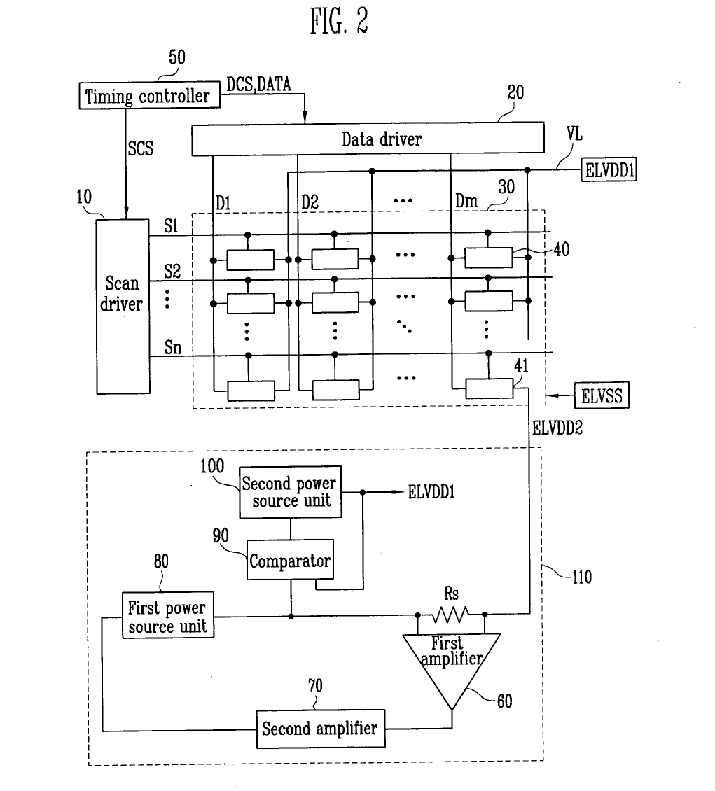

Hereinafter, an exemplary embodiment will be described with reference to FIG. 2 to FIG. 5.

FIG. 2 is a view showing an organic light emitting display according to an embodiment.

With reference to FIG. 2, the organic light emitting display includes a pixel portion 30 having pixels 40, a scan driver 10, a data driver 20, a timing controller 50, and a power source block 110. The pixels 40 are coupled to scan lines S1 through Sn and data lines D1 through Dm. The scan driver 10 drives the scan lines S1 through Sn. The data driver 20 drives the data lines D1 through Dm. The timing controller 50 controls the scan driver 10 and the data driver 20. The power source block 110 is coupled to a test pixel 41 of pixels 40 in the pixel portion 30. The power source block 100 generates a first power source ELVDD in order to compensate for a temperature and a degradation of an organic light emitting diode.

The timing controller 50 generates a data driving signal DCS and a scan driving signal SCS corresponding to synchronizing signals supplied from another circuit. The data driving signal DCS generated from the timing controller 50 is provided to the data driver 20, and the scan driving signal SCS is provided to the scan driver 10. Further, the timing controller 50 provides a data signal Data to the data driver 20.

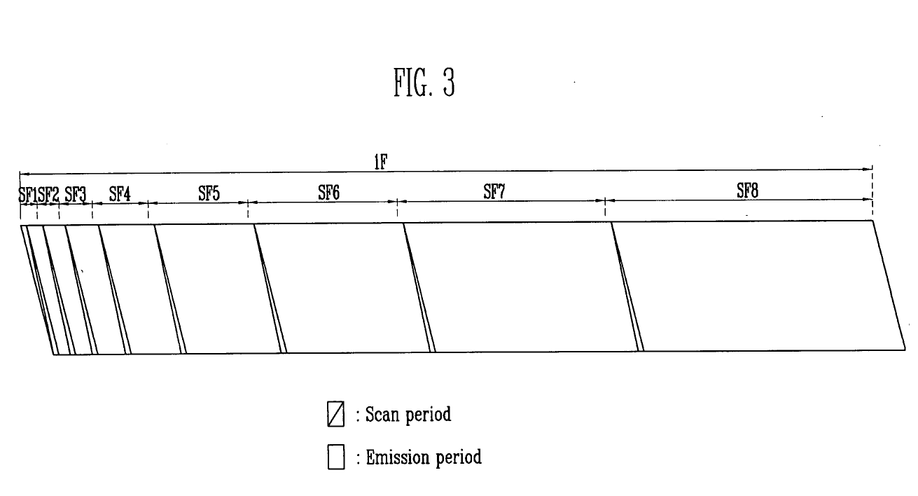

The scan driver 10 sequentially supplies a scan signal to the scan lines S1 through Sn. Referring to FIG. 3, the scan driver 10 sequentially supplies a scan signal to scan lines S1 to Sn during every scan period of sub frames in one frame 1F. When the scan signal is sequentially supplied to the scan lines S1 through Sn, the pixels 40 are sequentially selected by scan lines, and the selected pixels 40 receive a data signal from the data lines D1 to Dm.

The data driver 20 supplies a data signal to data lines D1 to Dm each time the scan signal is supplied during a scan period of a sub frame. Accordingly, the data signal is supplied to the pixels 40 selected by the scan signal. Meanwhile, the data driver 20 supplies a first data signal and a second data signal as the data signal. Here, the pixels 40 emit if they receive the first data signal and do not emit if they receive the second data signal. Accordingly, when the pixels have received the first data signal during an emission period of a sub frame, they display images by emitting light during a portion of the sub frame period.

The pixel portion 30 provides a first power source ELVDD1 from the power source block 110 to the pixels 40 through a power line VL. In addition, the pixel portion 30 provides a second power source ELVSS from an exterior to the pixels 40. After the pixels 40 receive the power of the first power source ELVDD and the power of the second power source ELVSS, when the scan signal is supplied, they receive a data signal, and emit light corresponding to the data signal. Here, a voltage of the first power source ELVDD is greater than that of the second power source ELVSS.

Meanwhile, the pixel portion 30 includes a test pixel 41, which is not coupled with the power line VL. The test pixel 41 is directly coupled to the power source block 110, and receives a third power source ELVDD2 from the power source block 110. The power source block 110 adjusts the voltage value of the third power source ELVDD2 so that a constant current is supplied to an organic light emitting diode included in the test pixel 41 regardless of a temperature and a degradation of the organic light emitting diode. Further, the power source block 100 sets a voltage value of the first power source ELVDD1 and the adjusted voltage value of the third power source ELVDD2 to have the same value, and supplies the first power source ELVDD1 to the pixel portion 30.

To do this, the power source block 100 includes a sensing resistor Rs, a first amplifier 70, a first power source unit 80, and a comparator 90, and a second power source unit 100.

A voltage corresponding to an electric current flowing through the specific pixel 41 is applied to the sensing resistor Rs corresponding to the third power source ELVDD2.

The first amplifier 60 amplifies, buffers, and provides the voltage applied to the sensing resistor Rs, to the second amplifier 70. Namely, the first amplifier 60 detects a current flowing through the sensing resistor Rs.

The second amplifier 70 is a peak to peak hold amplifier. The second amplifier 70 converts a voltage supplied from the first amplifier 60 into a DC voltage, and provides the DC voltage to the first power source unit 80 during a predetermined time period.

The first power source unit 80 controls a voltage value of the third power source ELVDD2 so that the voltage supplied from the second amplifier 70 becomes substantially identical with an internal reference voltage. Here, the internal reference voltage is an ideal voltage value applied to the sensing resistor Rs when a desired electric current to the specific pixel 41. Accordingly, when the voltage value of the third power source ELVDD2 is adjusted so that the voltage supplied from the second amplifier 70 is substantially identical with the reference voltage, the desired current is being delivered to pixel 41.

The third power source ELVDD2 generated by the first power source unit 80 is provide to the comparator 90. The comparator 90 compares the voltage value of the third power source ELVDD2 with the voltage value of the first power source ELVDD1, and provides a comparison result to the second power source unit 100. Accordingly, the second power source unit 100 adjusts the voltage value of the first power source ELVDD1 to be substantially identical with that of the third power source ELVDD2, and provides the adjusted first power source ELVDD1 to the pixel portion 30.

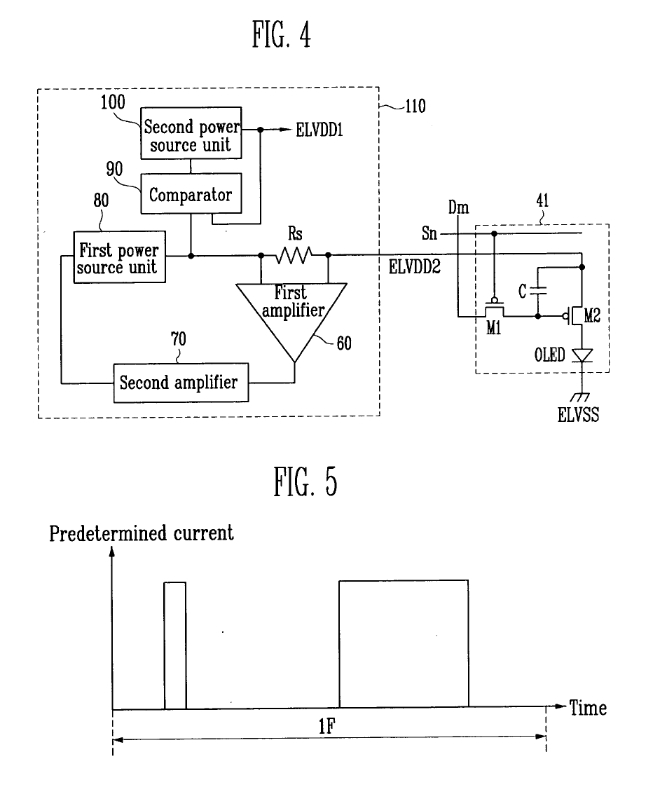

FIG. 4 is a view showing a coupling structure of the power source block and the pixel shown in FIG. 2.

The following is a description of the organic light emitting display referring to FIG. 4. First, when a scan signal is supplied to an n-th scan line Sn, a data signal is provide to a data line Dm. The data driver 20 controls the data signal so that the pixel 41 may emit light during at least one sub frame of one frame period. For example, when black images are expressed on an entire screen during one frame period, the data signal is supplied to the pixel 41 to express luminance of one gradation. In this case, although the luminance of one gradation is expressed on the specific pixel 41, it does not have a significant affect on image quality.

When the first data signal is supplied to the data line Dm, a second transistor M2 is turned-on. In this case, current flows to the organic light emitting diode OLED from the third power source ELVDD2 from the first power source unit 80 to the pixel 41. At this time, a voltage corresponding to the current is applied to the sensing resistor Rs.

The first amplifier 60 amplifies and transfers a voltage sensed at the sensing resistor Rs to the second amplifier 70. The second amplifier 70 converts the voltage supplied from the first amplifier 60 into a DC voltage, and provides the DC voltage to the first power source unit 80. Further, the second amplifier 70 maintains the DC voltage until a next voltage is supplied thereto from the first amplifier 60.

As shown in FIG. 5, a current flows through the sensing resistor Rs at least once during one frame period. When the current flows through the sensing resistor Rs at least once, the second amplifier 70 converts a voltage supplied through the sensing resistor Rs and the first amplifier 60 into a DC voltage, and supplies the DC voltage to the first power source unit 80 during a until a next voltage is supplied thereto.

The first power source unit 80 compares a voltage supplied from the second amplifier 70 with a reference voltage, and controls the third power source ELVDD2 so that the supplied voltage is substantially identical with (or similar to) the reference voltage. Next, the third power source ELVDD2 is provided to the comparator 80.

The comparator 90 compares the voltage value of the first power source ELVDD1 and a voltage value of the third power source ELVDD2, and provides a comparison result to the second power source unit 100. The second power source unit 100 adjusts the voltage value of the first power source ELVDD1 according to the comparison result of the comparator 90 so that the voltage value of the first power source ELVDD1 and the voltage value of the third power source ELVDD2 are substantially identical with each other. The second power source unit 100 provides the adjusted voltage value of the first power source ELVDD1 to the pixels through the power line VL. Accordingly, the pixels 40 may display images of desired luminance regardless of a temperature and a resistance increase of an organic light emitting diode.

The power source block 110 adjusts the voltage value of the third power source ELVDD2 so that an electric current flowing through the pixel 41 becomes a desired value, and sets the voltage value of the first power source ELVDD1 to have the same value as that of the third power source ELVDD2. Accordingly, a desired current can flow through the pixels 40 included in the pixel portion 30 corresponding to a data signal regardless of a temperature and a resistance increase in an organic light emitting diode. This causes images of desired luminance to be displayed. Furthermore, since a specific pixel included in the pixel portion is used without additional pixels, a separate dead space does not occur. In addition, since a desired electric current flows through each of the pixels 40 using the specific pixel 41, desired luminance may be precisely expressed.

As is seen from the forgoing description, in the organic light emitting display and a method for driving the same, a voltage of a third power source is controlled so that a desired electric current flows through a specific pixel included in the pixel portion, and a voltage of a first power source is adjusted to have the same value as that of the third power source. Accordingly, pixels can display images of uniform luminance regardless of a temperature and a resistance increased in an organic light emitting diode. In addition, because the display uses the specific pixel included in the pixel portion, dead spaces and unnecessary emission do not occur.

Although exemplary embodiments have been shown and described, it would be appreciated by those skilled in the art that changes might be made in these embodiments without departing from the principles and spirit of the invention.

What is claimed is:

1. An organic light emitting display, comprising:
a scan driver configured to sequentially supply a scan signal to scan lines during each scan period of a plurality of sub frames of one frame;
a data driver configured to supply a data signal to data lines when the scan signal is supplied;
a pixel portion, including pixels configured to receive a first power source supplied through a power source line and a second power source; and
a test pixel included in the pixel portion, the test pixel configured to receive the second power source and a third power source from a power source block, wherein
the power source block is configured to control the voltage value of the third power source according to a current supplied to the test pixel, and to generate and supply the first power source to the pixels, the first power source having substantially the same voltage value as that of the third power source.

2. The organic light emitting display as claimed in claim 1, wherein the power source block includes:
a first power source unit configured to generate the third power source;
a sensing resistor coupled between the first power source unit and the test pixel;
a first amplifier configured to amplify a voltage applied to the sensing resistor; and
a second amplifier configured to convert a voltage applied to the first amplifier into a direct current voltage and to supply the direct current voltage to the first power source unit.

3. The organic light emitting display as claimed in claim 2, wherein the first power source unit is configured to compare a voltage from the second amplifier with a reference voltage when a desired electric current flows to the test pixel, and adjusts the voltage value of the third power source so that the voltage supplied from the second amplifier is substantially identical with the reference voltage.

4. The organic light emitting display as claimed in claim 3, wherein the power source block further includes:
a second power source unit configured to generate the first power source; and
a comparator configured to compare the voltage of the third power source with the voltage of the first power source.

5. The organic light emitting display as claimed in claim 4, wherein the second power source unit is configured to adjust the voltage of the first power source so that the first power source and the third power source are substantially equal.

6. The organic light emitting display as claimed in claim 2, wherein the second amplifier comprises a peak to peak hold amplifier.

7. The organic light emitting display as claimed in claim 1, wherein the data driver supplies one of a first data signal and a second data signal to the data lines during a time that the scan signal is applied to the scan lines, the first data signals causing the pixels to emit light and the second data signals causing the pixels to not emit light.

8. The organic light emitting display as claimed in claim 7, wherein the data driver supplies the first data signal to the test pixel during at least one sub frame period of the one frame period.

9. A method of driving an organic light emitting display which comprises a pixel portion disposed near intersections of scan lines and data lines and including pixels coupled between a first power source and a second power source, wherein a frame is divided in a plurality of sub frames, the method comprising:
supplying a voltage of a third power source to a test pixel of the pixel portion;
extracting a voltage corresponding to an electric current flowing through the test pixel using a sensing resistor;
adjusting the voltage of the third power source so that the extracted voltage is substantially the same as a reference voltage; and
adjusting a voltage of the first power source to be substantially the same as that of the third power source.

10. The method as claimed in claim 9, wherein the pixels having received the first power source emit light while conducting an electric current from the first power source to the second power source through an organic light emitting diode.

11. The method as claimed in claim 9, further comprising:
amplifying the voltage at the sensing resistor;
converting the amplified voltage into a direct current voltage; and
maintaining the direct current voltage while the voltage at the sensing resistor changes.

12. The method as claimed in claim 9, wherein a first data signal applied to the pixels causes the pixels to emit light and a second data signal applied to the pixels causes the pixels to not emit light, and the first data signal is supplied to the test pixel during at least one of a plurality of sub frame periods within one frame period.

13. An organic light emitting display, comprising:
a pixel portion, comprising a plurality of pixels configured to receive a first power source; and
a power source block, configured to generate the first power source by adjusting a voltage applied to a test pixel of the plurality of pixels until a desired current is supplied to the test pixel, and adjusting the first power source until the first power source has a voltage value substantially equal to the adjusted voltage applied to the test pixel.

14. The organic light emitting display as claimed in claim 13, wherein the power source block comprises a sensing resistor, and the desired current is sensed by the sensing resistor.

15. The organic light emitting display as claimed in claim 14, wherein the sensing resistor is configured to generate a sense voltage based on the current applied to the test pixel, and the first power source is adjusted based at least in part on the sense voltage.

16. The organic light emitting display as claimed in claim 15, wherein the power source block comprises a first amplifier configured to buffer the sense voltage, and the first power source is adjusted based at least in part on the buffered sense voltage.

17. The organic light emitting display as claimed in claim 16, wherein the power source block comprises a second amplifier configured to generate an amplified sense voltage, and the first power source is adjusted based at least in part on the amplified sense voltage.

18. The organic light emitting display as claimed in claim 17, wherein the power source block comprises a first power source unit configured to generate the voltage applied to the test pixel based on the amplified sense voltage.

19. The organic light emitting display as claimed in claim 18, wherein the power source block comprises a comparator configured to generate a comparison signal based on the difference between the first power source and the voltage applied to the test pixel.

20. The organic light emitting display as claimed in claim 19, wherein the power source block comprises a second power source unit configured to generate the first power source based on the comparison signal.
